(19) United States
(12) Patent Application Publication
(10) Pub. No.: US 2023/0299355 A1
(43) Pub. Date: Sep. 21, 2023

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Midori SAITOU, Kyoto (JP); Takuju HASHIMOTO, Kyoto (JP)

(21) Appl. No.: 18/203,365

(22) Filed: May 30, 2023

Related U.S. Application Data
(63) Continuation of application No. PCT/JP2022/006456, filed on Feb. 17, 2022.

(30) Foreign Application Priority Data
Mar. 15, 2021 (JP) 2021-041882

(51) Int. Cl. H01M 10/0567; H01M 10/0525

(52) U.S. Cl. CPC H01M 10/0567; H01M 10/0525; H01M 2300/004

(57) ABSTRACT

A secondary battery includes a positive electrode, a negative electrode, and an electrolytic solution. The electrolytic solution includes a diester compound and a sulfur-containing compound. The diester compound includes two or more of a compound represented by Formula (1), a compound represented by Formula (2), or a compound represented by Formula (3). The sulfur-containing compound includes at least one of propane sultone, 1,4-butane sultone, 2,4-butane sultone, propene sultone, glycol sulfate, propylene glycol sulfate, dimethyl sulfate, diethyl sulfate, ethyl methyl sulfate, or sulfolane.

### CROSS REFERENCE TO RELATED APPLICATIONS

The present application is a continuation of PCT patent application no. PCT/JP2022/006456, filed on Feb. 17, 2022, which claims priority to Japanese patent application no. JP2021-041882, filed on Mar. 15, 2021, the entire contents of which are incorporated herein by reference.

### BACKGROUND

The present technology relates to an electrolytic solution for a secondary battery, and a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution (an electrolytic solution for a secondary battery). A configuration of the secondary battery has been considered in various ways.

In order to improve high-temperature lifetime performance, a non-aqueous electrolyte includes: ethylene carbonate, propylene carbonate, or both; a chain carboxylic acid ester; and a carbonyloxy ester compound. In order to improve high-rate discharge characteristic, a non-aqueous electrolytic solution includes an alkylene biscarbonate compound.

In order to suppress a decrease in discharging capacity in a charge and discharge cycle, a non-aqueous electrolyte includes a cyclic carbonic acid ester, a chain carboxylic acid ester, and a diester compound. In order to improve a low-temperature cyclability characteristic, a non-aqueous electrolytic solution includes a cyclic carbonic acid ester, a chain carbonic acid ester, an additive represented by R1—O—C(═O)—O—(CR3R4)ₙ—O—C(═O)—R2, and a monofluorophosphoric acid salt or a difluorophosphoric acid salt.

### SUMMARY

The present technology relates to an electrolytic solution for a secondary battery, and a secondary battery.

Although consideration has been given in various ways regarding a battery characteristic of a secondary battery, the secondary battery still remains insufficient in a high-temperature storage characteristic. Accordingly, there is room for improvement in terms thereof.

It is therefore desirable to provide an electrolytic solution for a secondary battery and a secondary battery each of which makes it possible to improve high-temperature storage characteristic according to an embodiment of the present technology.

An electrolytic solution for a secondary battery according to an embodiment of the present technology includes a diester compound and a sulfur-containing compound. The diester compound includes two or more of a compound represented by Formula (1), a compound represented by Formula (2), or a compound represented by Formula (3). The sulfur-containing compound includes at least one of propane sultone, 1,4-butane sultone, 2,4-butane sultone, propene sultone, glycol sulfate, propylene glycol sulfate, dimethyl sulfate, diethyl sulfate, ethyl methyl sulfate, or sulfolane.

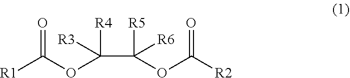

### Where:

each of R1 and R2 is one of a methyl group, an ethyl group, a propyl group, or a fluorine group; and
each of R3 to R6 is one of a hydrogen group, a methyl group, or a fluorine group.

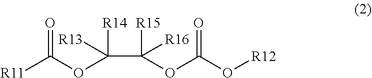

### Where:

R11 is one of a methyl group, an ethyl group, a propyl group, or a fluorine group;
R12 is one of a methyl group, an ethyl group, or a propyl group; and
each of R13 to R16 is one of a hydrogen group, a methyl group, or a fluorine group.

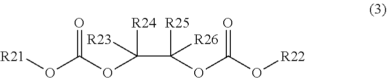

### Where:

each of R21 and R22 is one of a methyl group, an ethyl group, or a propyl group; and
each of R23 to R26 is one of a hydrogen group, a methyl group, or a fluorine group.

A secondary battery according to an embodiment of the present technology includes a positive electrode, a negative electrode, and an electrolytic solution. The electrolytic solution has a configuration similar to the configuration of the electrolytic solution for a secondary battery according to the embodiment of the present technology described above.

Here, the foregoing wording “the diester compound includes two or more of the compound represented by Formula (1), the compound represented by Formula (2), or the compound represented by Formula (3)” refers to that the diester compound has a configuration of any of the following four patterns.

First, the diester compound includes a combination of two compounds: the compound represented by Formula (1) and the compound represented by Formula (2). Second, the diester compound includes a combination of two compounds: the compound represented by Formula (2) and the compound represented by Formula (3). Third, the diester compound includes a combination of two compounds: the compound represented by Formula (1) and the compound represented by Formula (3). Fourth, the diester compound includes a combination of three compounds: the compound represented by Formula (1), the compound represented by Formula (2), and the compound represented by Formula (3).

That is, a configuration in which the diester compound includes only one of the compound represented by Formula (1), the compound represented by Formula (2), or the compound represented by Formula (3) is excluded from the configuration of the diester compound described here.

According to the electrolytic solution for a secondary battery or the secondary battery of an embodiment of the present technology, the electrolytic solution for a secondary battery includes the diester compound and the sulfur-containing compound. Accordingly, it is possible to achieve an enhanced high-temperature storage characteristic.

Note that effects of the present technology are not necessarily limited to those described herein and may include any of a series of suitable effects in relation to the present technology.

### BRIEF DESCRIPTION OF THE FIGURES

FIG. 1 is a perspective view of a configuration of a secondary battery according to an embodiment of the present technology.

FIG. 2 is a sectional view of a configuration of a battery device illustrated in FIG. 1.

FIG. 3 is a block diagram illustrating a configuration of an application example of the secondary battery.

### DETAILED DESCRIPTION

One or more embodiments of the present technology are described below in further detail including with reference to the drawings.

A description is provided of an electrolytic solution for a secondary battery (hereinafter simply referred to as an “electrolytic solution”) according to an embodiment of the present technology.

The electrolytic solution is to be used in a secondary battery. However, the electrolytic solution may be used in an electrochemical unit other than a secondary battery. The other electrochemical unit is not particularly limited in kind, and specific examples thereof include a capacitor.

The electrolytic solution includes a diester compound and a sulfur-containing compound.

A reason why the electrolytic solution includes the diester compound and the sulfur-containing compound together is that, upon charging and discharging of a secondary battery using the electrolytic solution, a high-quality film derived from both the diester compound and the sulfur-containing compound is formed on a surface of an electrode. As a result, the surface of the electrode is electrochemically protected, and a decomposition reaction of the electrolytic solution on the surface of the electrode is therefore suppressed. In this case, in particular, even if the secondary battery is stored in a high-temperature environment, the decomposition reaction of the electrolytic solution is effectively suppressed.

The diester compound is a compound including two ester bonds.

For example, the diester compound includes two or more of a compound represented by Formula (1), a compound represented by Formula (2), or a compound represented by Formula (3). That is, as described above, unless the diester compound includes only one of the three respective compounds represented by Formulae (1) to (3), the diester compound may include any two of the three compounds, or may include all of the three compounds.

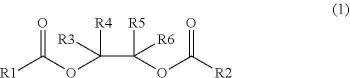

Where:
each of R1 and R2 is one of a methyl group, an ethyl group, a propyl group, or a fluorine group; and
each of R3 to R6 is one of a hydrogen group, a methyl group, or a fluorine group.

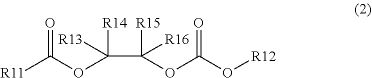

### Where:

R11 is one of a methyl group, an ethyl group, a propyl group, or a fluorine group;
R12 is one of a methyl group, an ethyl group, or a propyl group; and
each of R13 to R16 is one of a hydrogen group, a methyl group, or a fluorine group.

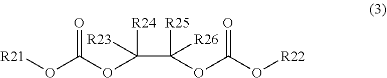

### Where:

each of R21 and R22 is one of a methyl group, an ethyl group, or a propyl group; and
each of R23 to R26 is one of a hydrogen group, a methyl group, or a fluorine group.

A reason why the diester compound includes two or more of the three respective compounds represented by Formulae (1) to (3) is that, unlike a case of using only one of the compounds, the combination use of two or more of the compounds that are slightly different from each other in decomposition potential allows for continuous proceeding of a film formation reaction on the surface of the electrode, resulting in formation of a firmer film.

In the following, the compound represented by Formula (1) is referred to as a “first diester compound”, the compound represented by Formula (2) is referred to as a “second diester compound”, and the compound represented by Formula (3) is referred to as a “third diester compound”.

The first diester compound is a chain compound including two end groups, that is, —O—C(═O)—R1 and —O—C(═O)—R2, as represented by Formula (1). Only one first diester compound may be used, or two or more first diester compounds may be used.

R1 and R2 may be the same as each other in kind, or may be different from each other in kind. R3 to R6 may be the same as each other in kind, or may be different from each other in kind. It goes without saying that only any two or three of R3 to R6 may be the same as each other in kind. Note that the propyl group may have a straight-chain structure, or may have a branched structure. That is, the propyl group may be a normal propyl group, or may be an isopropyl group.

R1 is not particularly limited as long as R1 is one of a methyl group, an ethyl group, a propyl group, or a fluorine group, as described above. This similarly applies to R2.

R3 is not particularly limited as long as R3 is one of a hydrogen group, a methyl group, or a fluorine group, as described above. This similarly applies to each of R4 to R6.

The second diester compound is a chain compound including two end groups, that is, —O—C(═O)—R11 and —O—C(═O)—O—R12, as represented by Formula (2). Only one second diester compound may be used, or two or more second diester compounds may be used.

R11 and R12 may be the same as each other in kind, or may be different from each other in kind. R13 to R16 may be the same as each other in kind, or may be different from each other in kind. It goes without saying that only any two or three of R13 to R16 may be the same as each other in kind.

R11 is not particularly limited as long as R11 is one of a methyl group, an ethyl group, a propyl group, or a fluorine group, as described above. R12 is not particularly limited as long as R12 is one of a methyl group, an ethyl group, or a propyl group, as described above. As described here, candidates for R11 bonded to a carbon atom include a fluorine group, whereas candidates for R12 bonded to an oxygen atom do not include a fluorine group.

R13 is not particularly limited as long as R13 is one of a hydrogen group, a methyl group, or a fluorine group, as described above. This similarly applies to each of R14 to R16.

The third diester compound is a chain compound including two end groups, that is, —O—C(═O)—O—R21 and —O—C(═O)—O—R22, as represented by Formula (3). Only one third diester compound may be used, or two or more third diester compounds may be used.

R21 and R22 may be the same as each other in kind, or may be different from each other in kind. R23 to R26 may be the same as each other in kind, or may be different from each other in kind. It goes without saying that only any two or three of R23 to R26 may be the same as each other in kind.

R21 is not particularly limited as long as R21 is one of a methyl group, an ethyl group, or a propyl group, as described above. This similarly applies to R22.

R23 is not particularly limited as long as R23 is one of a hydrogen group, a methyl group, or a fluorine group, as described above. This similarly applies to each of R24 to R26.

Specific examples of the diester compounds include the following according to an embodiment.

Specific examples of the first diester compound include respective compounds represented by Formulae (1-1) to (1-14).

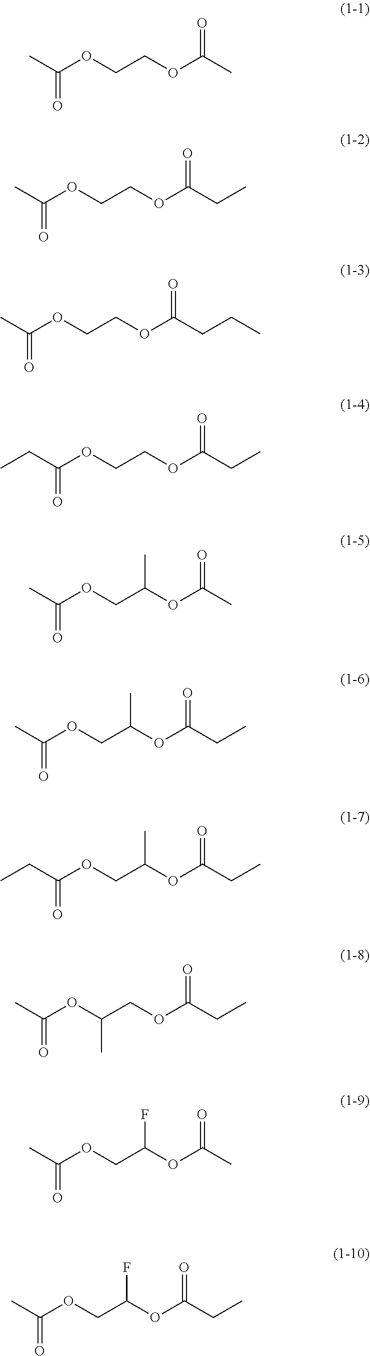

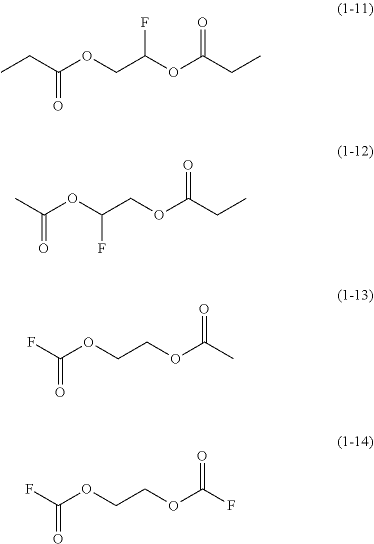

Specific examples of the second diester compound include respective compounds represented by Formulae (2-1) to (2-22).

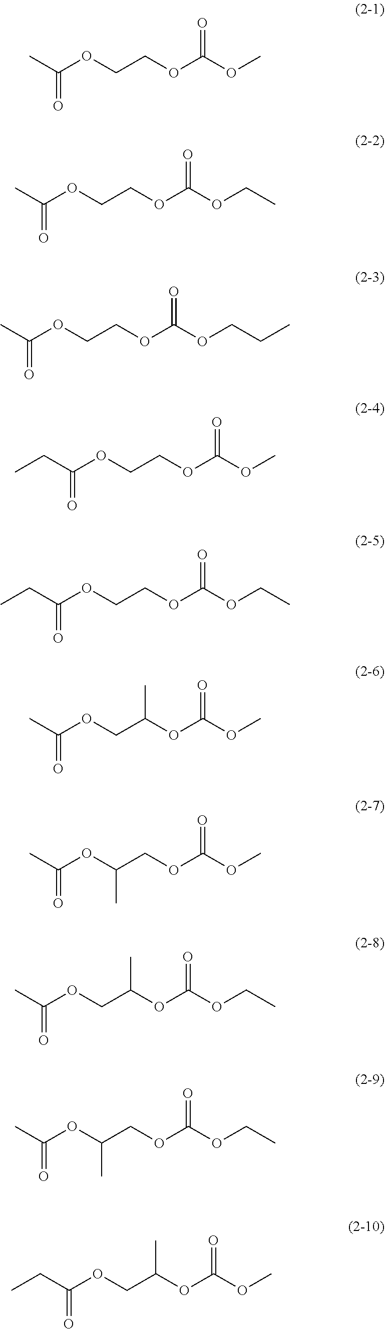

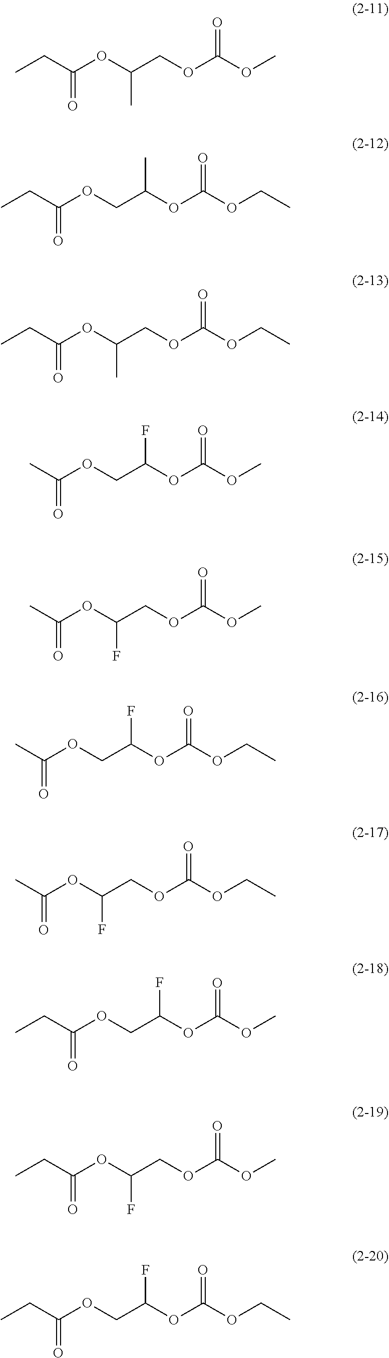

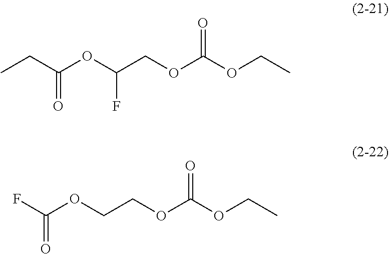

Specific examples of the third diester compound include respective compounds represented by Formulae (3-1) to (3-13).

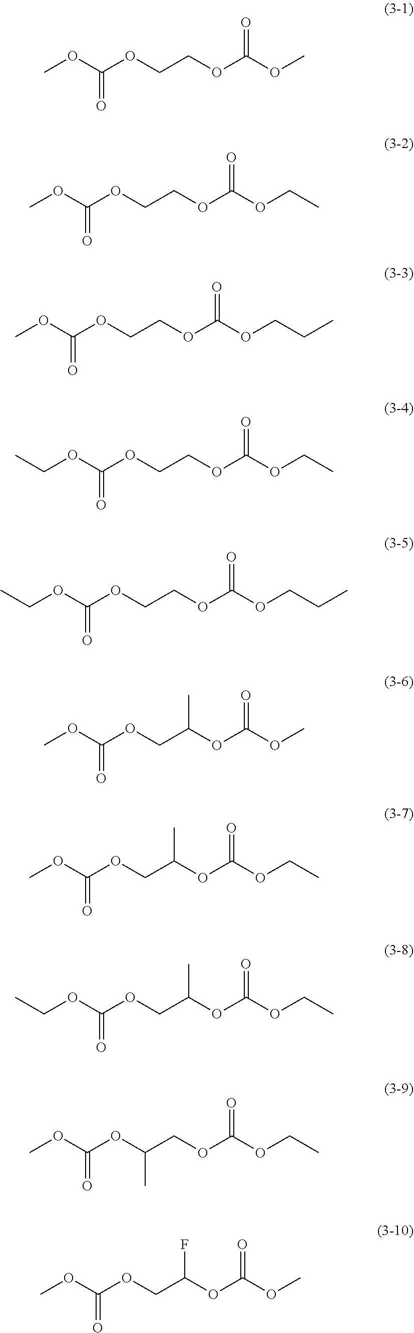

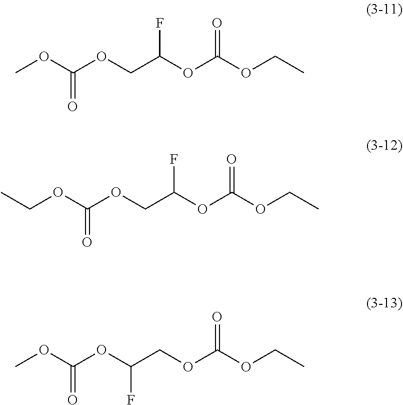

Among the above, the diester compound preferably includes the first diester compound and the second diester compound according to an embodiment. That is, in a case where the diester compound includes two of the first diester compound, the second diester compound, or the third diester compound, the diester compound preferably includes a combination of the first diester compound and the second diester compound. A reason for this is that the film is formed with higher quality, and the decomposition reaction of the electrolytic solution is therefore further suppressed.

Although not particularly limited, a content of the diester compound in the electrolytic solution is preferably within a range from 0.005 wt % to 1 wt % both inclusive, in particular. A reason for this is that the film is formed with sufficiently high quality, and the decomposition reaction of the electrolytic solution is therefore sufficiently suppressed.

The content of the diester compound described here is the sum total of the respective contents of the first diester compound, the second diester compound, and the third diester compound included in the electrolytic solution.

The sulfur-containing compound is a compound including sulfur as a constituent element.

Specifically, the sulfur-containing compound includes one or more of ten respective compounds represented by Formulae (4-1) to (4-10). That is, the sulfur-containing compound may include only one of the ten compounds described above, or may include any two or more of the ten compounds.

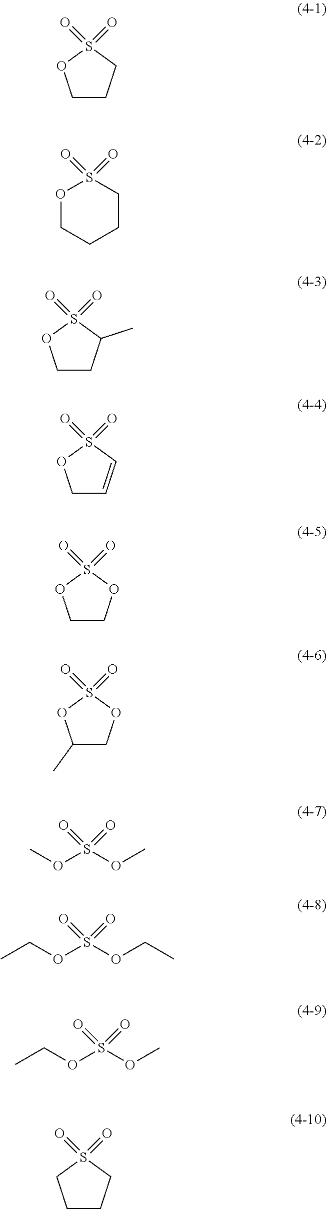

The compound represented by Formula (4-1) is propane sultone. The compound represented by Formula (4-2) is 1,4-butane sultone. The compound represented by Formula (4-3) is 2,4-butane sultone. The compound represented by Formula (4-4) is propene sultone. The compound represented by Formula (4-5) is glycol sulfate. The compound represented by Formula (4-6) is propylene glycol sulfate. The compound represented by Formula (4-7) is dimethyl sulfate. The compound represented by Formula (4-8) is diethyl sulfate. The compound represented by Formula (4-9) is ethyl methyl sulfate. The compound represented by Formula (4-10) is sulfolane.

Although not particularly limited, a content of the sulfur-containing compound in the electrolytic solution is preferably within a range from 0.1 wt % to 3 wt % both inclusive, in particular. A reason for this is that the film is formed with sufficiently high quality, and the decomposition reaction of the electrolytic solution is therefore sufficiently suppressed.

The electrolytic solution may further include one or more of solvents.

The solvent includes one or more of non-aqueous solvents (organic solvents), and the electrolytic solution including the non-aqueous solvent(s) is a so-called non-aqueous electrolytic solution. The non-aqueous solvent is, for example, an ester or an ether, more specifically, a carbonic-acid-ester-based compound, a carboxylic-acid-ester-based compound, or a lactone-based compound, for example.

The carbonic-acid-ester-based compound is, for example, a cyclic carbonic acid ester or a chain carbonic acid ester. Specific examples of the cyclic carbonic acid ester include ethylene carbonate and propylene carbonate. Specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include methyl acetate, ethyl acetate, methyl propionate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, the lactone-based compound described above, 1,2-dimethoxyethane, tetrahydrofuran, 1,3-dioxolane, or 1,4-dioxane.

In addition, the electrolytic solution may further include one or more of electrolyte salts. The electrolyte salt is a light metal salt, and is more specifically a lithium salt, for example.

Specific examples of the lithium salt include lithium hexafluorophosphate (LiPF₆), lithium tetrafluoroborate (LiBF₄), lithium trifluoromethanesulfonate (LiCF₃SO₃), lithium pentafluoroethanesulfonate (LiC₂F₅SO₃), lithium bis(fluorosulfonyl)imide (LiN(FSO₂)₂), lithium bis(trifluoromethanesulfonyl)imide (LiN(CF₃SO₂)₂), lithium bis(pentafluoroethanesulfonyl)imide (LiN(C₂F₅SO₂)₂), lithium tris(trifluoromethanesulfonyl)methide (LiC(CF₃SO₂)₃), lithium bis(oxalato)borate (LiB(C₂O₄)₂), lithium difluoro(oxalato)borate (LiB(C₂O₄)F₂), lithium monofluorophosphate (Li₂PFO₃), and lithium difluorophosphate (LiPF₂O₂).

A content of the electrolyte salt is not particularly limited, and is specifically within a range from 0.3 mol/kg to 3.0 mol/kg both inclusive with respect to the solvent. A reason for this is that high ion conductivity is obtainable.

Note that the electrolytic solution may further include one or more of additives. The additives are not particularly limited in kind, and specific examples thereof include an unsaturated cyclic carbonic acid ester, a halogenated carbonic acid ester, a phosphoric acid ester, an acid anhydride, a nitrile compound, and an isocyanate compound. A reason for this is that chemical stability of the electrolytic solution improves, and the decomposition reaction of the electrolytic solution is therefore suppressed.

Specific examples of the unsaturated cyclic carbonic acid ester include vinylene carbonate, vinylethylene carbonate, and methylene ethylene carbonate. Specific examples of the halogenated carbonic acid ester include a halogenated cyclic carbonic acid ester and a halogenated chain carbonic acid ester. Specific examples of the halogenated cyclic carbonic acid ester include monofluoroethylene carbonate and difluoroethylene carbonate. Specific examples of the halogenated chain carbonic acid ester include fluoromethyl methyl carbonate, bis(fluoromethyl)carbonate, and difluoromethyl methyl carbonate. Specific examples of the phosphoric acid ester include trimethyl phosphate and triethyl phosphate.

The acid anhydride is a dicarboxylic acid anhydride, a disulfonic acid anhydride, or a carboxylic acid sulfonic acid anhydride, for example. Specific examples of the dicarboxylic acid anhydride include succinic anhydride, glutaric anhydride, and maleic anhydride. Specific examples of the disulfonic acid anhydride include ethanedisulfonic anhydride and propanedisulfonic anhydride. Specific examples of the carboxylic acid sulfonic acid anhydride include sulfobenzoic anhydride, sulfopropionic anhydride, and sulfobutyric anhydride.

The nitrile compound is a mononitrile compound, a dinitrile compound, or a trinitrile compound, for example. Specific examples of the mononitrile compound include acetonitrile. Specific examples of the dinitrile compound include succinonitrile, glutaronitrile, adiponitrile, and 3,3′-(ethylenedioxy)dipropionitrile. Specific examples of the trinitrile compound include 1,2,3-propanetricarbonitrile, 1,3,5-pentanetricarbonitrile, 1,3,4-hexanetricarbonitrile, 1,3,6-hexanetricarbonitrile, 1,3,5-cyclohexanetricarbonitrile, and 1,3,5-benzenetricarbonitrile. Specific examples of the isocyanate compound include hexamethylene diisocyanate.

In a case of manufacturing the electrolytic solution, the electrolyte salt is added to the solvent, following which the diester compound and the sulfur-containing compound are added to the solvent. In this case, two or more of the first diester compound, the second diester compound, or the third diester compound are used as the diester compound, as described above. The electrolyte salt, the diester compound, and the sulfur-containing compound are thereby each dispersed or dissolved in the solvent. As a result, the electrolytic solution is prepared.

According to the electrolytic solution, the electrolytic solution includes the diester compound and the sulfur-containing compound. The diester compound includes two or more of the first diester compound, the second diester compound, or the third diester compound. The sulfur-containing compound includes, without limitation, propane sultone.

In this case, as compared with a case where the electrolytic solution does not include the diester compound and the sulfur-containing compound, the film is formed with high quality on the surface of the electrode upon the charging and discharging, and the decomposition reaction of the electrolytic solution on the surface of the electrode is therefore suppressed, as described above. The decomposition reaction of the electrolytic solution is thus suppressed even if the secondary battery is stored in a high-temperature environment. It is therefore possible to achieve a superior high-temperature storage characteristic.

Note that the above-described case where the electrolytic solution does not include the diester compound and the sulfur-containing compound are: (1) a case where the electrolytic solution includes neither the diester compound nor the sulfur-containing compound; (2) a case where the electrolytic solution includes only either the diester compound or the sulfur-containing compound; and (3) a case where the electrolytic solution includes both the diester compound and the sulfur-containing compound, but the diester compound includes only one of the first diester compound, the second diester compound, or the third diester compound.

In particular, the diester compound may include the first diester compound and the second diester compound. This further suppresses the decomposition reaction of the electrolytic solution. Accordingly, it is possible to achieve higher effects.

Further, the content of the diester compound in the electrolytic solution may be within the range from 0.005 wt % to 1 wt % both inclusive. This sufficiently suppresses the decomposition reaction of the electrolytic solution. Accordingly, it is possible to achieve higher effects.

Further, the content of the sulfur-containing compound in the electrolytic solution may be within the range from 0.1 wt % to 3 wt % both inclusive. This sufficiently suppresses the decomposition reaction of the electrolytic solution. Accordingly, it is possible to achieve higher effects.

A description is given next of a secondary battery including the electrolytic solution described above.

The secondary battery to be described here is a secondary battery that obtains a battery capacity using insertion and extraction of an electrode reactant, and includes a positive electrode, a negative electrode, and an electrolytic solution which is a liquid electrolyte.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

Examples are given below of a case where the electrode reactant is lithium. A secondary battery that obtains a battery capacity using insertion and extraction of lithium is a so-called lithium-ion secondary battery. In the lithium-ion secondary battery, lithium is inserted and extracted in an ionic state.

Here, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

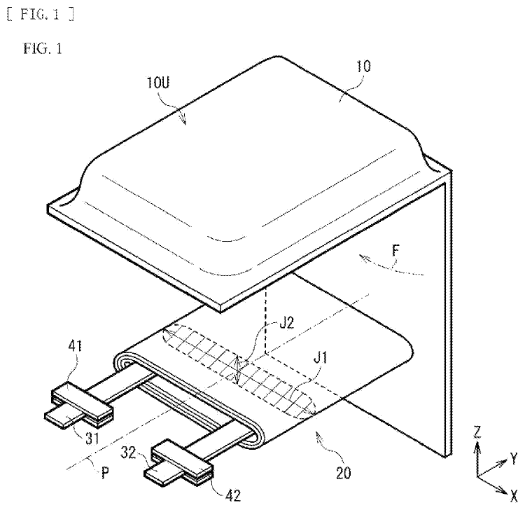

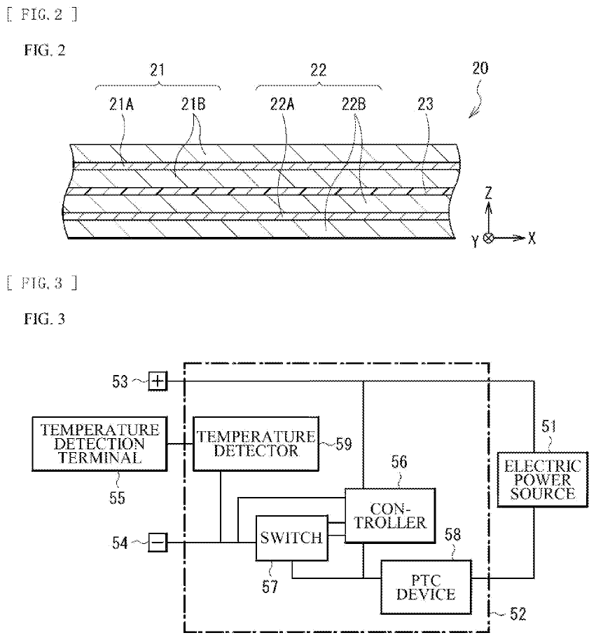

FIG. 1 illustrates a perspective configuration of the secondary battery. FIG. 2 illustrates a sectional configuration of a battery device 20 illustrated in FIG. 1. Note that FIG. 1 illustrates a state in which an outer package film 10 and the battery device 20 are separated from each other, and illustrates a section of the battery device 20 along an XZ plane by a dashed line. FIG. 2 illustrates only a portion of the battery device 20.

As illustrated in FIGS. 1 and 2, the secondary battery includes the outer package film 10, the battery device 20, a positive electrode lead 31, a negative electrode lead 32, and sealing films 41 and 42. The secondary battery described here is a secondary battery of a laminated-film type in which the outer package film 10 having flexibility or softness is used.

As illustrated in FIG. 1, the outer package film 10 is a flexible outer package member that contains the battery device 20. The outer package film 10 has a pouch-shaped structure in which the battery device 20 is sealed in a state of being contained inside the outer package film 10. The outer package film 10 thus contains a positive electrode 21, a negative electrode 22, and an electrolytic solution that are to be described later.

Here, the outer package film 10 is a single film-shaped member, and is folded toward a folding direction F. The outer package film 10 has a depression part 10U to place the battery device 20 therein. The depression part 10U is a so-called deep drawn part.

Specifically, the outer package film 10 is a three-layered laminated film including a fusion-bonding layer, a metal layer, and a surface protective layer that are stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry, for example, of outside air into the outer package film 10. The sealing film 41 includes a polymer compound such as a polyolefin that has adherence to the positive electrode lead 31. Examples of the polyolefin include polypropylene.

A configuration of the sealing film 42 is similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

As illustrated in FIGS. 1 and 2, the battery device 20 is a power generation device that includes the positive electrode 21, the negative electrode 22, a separator 23, and the electrolytic solution (not illustrated). The battery device 20 is contained inside the outer package film 10.

The battery device 20 is a so-called wound electrode body. That is, in the battery device 20, the positive electrode 21 and the negative electrode 22 are stacked on each other with the separator 23 interposed therebetween, and the positive electrode 21, the negative electrode 22, and the separator 23 are wound about a winding axis P. The winding axis P is a virtual axis extending in a Y-axis direction. Thus, the positive electrode 21 and the negative electrode 22 are opposed to each other with the separator 23 interposed therebetween, and are wound.

A three-dimensional shape of the battery device 20 is not particularly limited. Here, the battery device 20 has an elongated shape. Accordingly, a section of the battery device 20 intersecting the winding axis P, that is, a section of the battery device 20 along the XZ plane, has an elongated shape defined by a major axis J1 and a minor axis J2. The major axis J1 is a virtual axis that extends in an X-axis direction and has a larger length than the minor axis J2. The minor axis J2 is a virtual axis that extends in a Z-axis direction intersecting the X-axis direction and has a smaller length than the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B.

The positive electrode current collector 21A has two opposed surfaces on each of which the positive electrode active material layer 21B is to be provided. The positive electrode current collector 21A includes an electrically conductive material such as a metal material. Examples of the metal material include aluminum.

The positive electrode active material layer 21B includes one or more of positive electrode active materials into which lithium is insertable and from which lithium is extractable. Note that the positive electrode active material layer 21B may further include one or more of other materials including, without limitation, a positive electrode binder and a positive electrode conductor.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A on a side where the positive electrode 21 is opposed to the negative electrode 22. A method of forming the positive electrode active material layer 21B is not particularly limited, and specifically includes one or more of methods including, without limitation, a coating method.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically an oxide, a phosphoric acid compound, a silicic acid compound, or a boric acid compound, for example.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride, polyimide, and carboxymethyl cellulose.

The positive electrode conductor includes one or more of electrically conductive materials including, without limitation, a carbon material. Examples of the carbon material include graphite, carbon black, acetylene black, and Ketjen black. Note that the electrically conductive material may be a metal material or a polymer compound, for example.

The negative electrode 22 includes, as illustrated in FIG. 2, a negative electrode current collector 22A and a negative electrode active material layer 22B.

The negative electrode current collector 22A has two opposed surfaces on each of which the negative electrode active material layer 22B is to be provided. The negative electrode current collector 22A includes an electrically conductive material such as a metal material. Examples of the metal material include copper.

The negative electrode active material layer 22B includes one or more of negative electrode active materials into which lithium is insertable and from which lithium is extractable. Note that the negative electrode active material layer 22B may further include one or more of other materials including, without limitation, a negative electrode binder and a negative electrode conductor.

Here, the negative electrode active material layer 22B is provided on each of the two opposed surfaces of the negative electrode current collector 22A. Note that the negative electrode active material layer 22B may be provided only on one of the two opposed surfaces of the negative electrode current collector 22A on a side where the negative electrode 22 is opposed to the positive electrode 21. A method of forming the negative electrode active material layer 22B is not particularly limited, and specifically includes one or more of methods including, without limitation, a coating method, a vapor-phase method, a liquid-phase method, a thermal spraying method, and a firing (sintering) method.

The negative electrode active material is not particularly limited in kind, and specific examples thereof include a carbon material, a metal-based material, or both, for example. A reason for this is that a high energy density is obtainable. Specific examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Specific examples of such metal elements and metalloid elements include silicon, tin, or both. The metal-based material may be a simple substance, an alloy, a compound, a mixture of two or more thereof, or a material including two or more phases thereof. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

As illustrated in FIG. 2, the separator 23 is an insulating porous film interposed between the positive electrode 21 and the negative electrode 22, and allows lithium ions to pass therethrough while preventing contact (a short circuit) between the positive electrode 21 and the negative electrode 22. The separator 23 includes a polymer compound such as polyethylene.

The positive electrode 21, the negative electrode 22, and the separator 23 are each impregnated with the electrolytic solution, and the electrolytic solution has the configuration described above. That is, the electrolytic solution includes the diester compound and the sulfur-containing compound.

As illustrated in FIG. 1, the positive electrode lead 31 is a positive electrode terminal coupled to the positive electrode current collector 21A of the positive electrode 21, and is led from an inside to an outside of the outer package film 10. The positive electrode lead 31 includes an electrically conductive material such as a metal material. Examples of the metal material include aluminum. The positive electrode lead 31 is not particularly limited in shape, and specifically has any of shapes including, without limitation, a thin plate shape and a meshed shape.

As illustrated in FIG. 1, the negative electrode lead 32 is a negative electrode terminal coupled to the negative electrode current collector 22A of the negative electrode 22, and is led from the inside to the outside of the outer package film 10. The negative electrode lead 32 includes an electrically conductive material such as a metal material. Examples of the metal material include copper. Here, the negative electrode lead 32 is led in a direction similar to that in which the positive electrode lead 31 is led out. Note that details of a shape of the negative electrode lead 32 are similar to those of the shape of the positive electrode lead 31.

Upon charging the secondary battery, in the battery device 20, lithium is extracted from the positive electrode 21, and the extracted lithium is inserted into the negative electrode 22 via the electrolytic solution. Upon discharging the secondary battery, in the battery device 20, lithium is extracted from the negative electrode 22, and the extracted lithium is inserted into the positive electrode 21 via the electrolytic solution. Upon charging and discharging, lithium is inserted and extracted in an ionic state.

In a case of manufacturing the secondary battery, the positive electrode 21 and the negative electrode 22 are each fabricated, following which the secondary battery is fabricated using the positive electrode 21, the negative electrode 22, and the electrolytic solution, according to a procedure to be described below. Note that the procedure for preparing the electrolytic solution is as described above.

First, a mixture (a positive electrode mixture) in which the positive electrode active material, the positive electrode binder, and the positive electrode conductor are mixed with each other is put into a solvent to thereby prepare a positive electrode mixture slurry in a paste form. The solvent may be an aqueous solvent, or may be an organic solvent. Thereafter, the positive electrode mixture slurry is applied on the two opposed surfaces of the positive electrode current collector 21A to thereby form the positive electrode active material layers 21B. Lastly, the positive electrode active material layers 21B are compression-molded by means of, for example, a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the positive electrode 21 described above. Specifically, first, a mixture (a negative electrode mixture) in which the negative electrode active material, the negative electrode binder, and the negative electrode conductor are mixed with each other is put into a solvent to thereby prepare a negative electrode mixture slurry in a paste form. Details of the solvent are as described above. Thereafter, the negative electrode mixture slurry is applied on the two opposed surfaces of the negative electrode current collector 22A to thereby form the negative electrode active material layers 22B. Lastly, the negative electrode active material layers 22B are compression-molded. The negative electrode active material layers 22B are thus formed on the two respective opposed surfaces of the negative electrode current collector 22A. As a result, the negative electrode 22 is fabricated.

First, the positive electrode lead 31 is coupled to the positive electrode current collector 21A of the positive electrode 21 by a method such as a welding method, and the negative electrode lead 32 is coupled to the negative electrode current collector 22A of the negative electrode 22 by a method such as a welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to that of the battery device 20 except that the positive electrode 21, the negative electrode 22, and the separator 23 are each not impregnated with the electrolytic solution. Thereafter, the wound body is pressed by means of, for example, a pressing machine to thereby shape the wound body into an elongated shape.

Thereafter, the wound body is placed inside the depression part 10U, following which the outer package film 10 (the fusion-bonding layer/the metal layer/the surface protective layer) is folded to thereby cause portions of the outer package film 10 to be opposed to each other.

Thereafter, outer edge parts of two sides of the outer package film 10 (the fusion-bonding layer) opposed to each other are bonded to each other by a method such as a thermal-fusion-bonding method to thereby place the wound body inside the outer package film 10 having the pouch shape.

Lastly, the electrolytic solution is injected into the outer package film 10 having the pouch shape, following which outer edge parts of the remaining one side of the outer package film 10 (the fusion-bonding layer) are bonded to each other by a method such as a thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus fabricated. Accordingly, the battery device 20 is sealed in the outer package film 10 having the pouch shape. As a result, the secondary battery is assembled.

The assembled secondary battery is charged and discharged. Various conditions including, for example, an environment temperature, the number of times of charging and discharging (the number of cycles), and charging and discharging conditions may be set as desired. As a result, a film is formed on a surface of each of the positive electrode 21 and the negative electrode 22, which electrochemically stabilizes a state of the secondary battery. As a result, the secondary battery is completed.

According to the secondary battery, the secondary battery includes an electrolytic solution, and the electrolytic solution has the above-described configuration. In this case, a high-quality film is formed on the surface of each of the positive electrode 21 and the negative electrode 22 upon charging and discharging, and the decomposition reaction of the electrolytic solution is therefore suppressed, as described above. Accordingly, the decomposition reaction of the electrolytic solution is suppressed even if the secondary battery is stored in a high-temperature environment. It is therefore possible to achieve a superior high-temperature storage characteristic.

In particular, the secondary battery may include a lithium-ion secondary battery. This makes it possible to obtain a sufficient battery capacity stably through the use of insertion and extraction of lithium. Accordingly, it is possible to achieve higher effects.

Other action and effects of the secondary battery are similar to those of the electrolytic solution described above.

Next, modifications will be described according to an embodiment.

The configuration of the secondary battery described above is appropriately modifiable including as described below. Note that any of the following series of modifications may be combined with each other.

The separator 23 which is a porous film is used. However, although not specifically illustrated here, a separator of a stacked type including a polymer compound layer may be used instead of the separator 23.

Specifically, the separator of the stacked type includes a porous film having two opposed surfaces, and the polymer compound layer provided on one of or each of the two opposed surfaces of the porous film. A reason for this is that adherence of the separator to each of the positive electrode 21 and the negative electrode 22 improves to suppress irregular winding of the battery device 20. This helps to prevent the secondary battery from easily swelling even if the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. Examples of the insulating particles include inorganic particles, resin particles, or both. Specific examples of the inorganic particles include particles of: aluminum oxide, aluminum nitride, boehmite, silicon oxide, titanium oxide, magnesium oxide, and zirconium oxide. Specific examples of the resin particles include particles of acrylic resin and particles of styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, instead of applying the precursor solution on the porous film, the porous film may be immersed in the precursor solution. In addition, insulating particles may be included in the precursor solution.

In the case where the separator of the stacked type is used also, lithium ions are movable between the positive electrode 21 and the negative electrode 22, and similar effects are therefore obtainable. In this case, in particular, the secondary battery improves in safety, as described above. Accordingly, it is possible to achieve higher effects.

The electrolytic solution which is a liquid electrolyte is used. However, although not specifically illustrated here, an electrolyte layer which is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23. Note that the electrolyte layer may be interposed only between the positive electrode 21 and the separator 23, or may be interposed only between the negative electrode 22 and the separator 23.

Specifically, the electrolyte layer includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 21 and on one side or both sides of the negative electrode 22.

In the case where the electrolyte layer is used also, lithium ions are movable between the positive electrode 21 and the negative electrode 22 via the electrolyte layer, and similar effects are therefore obtainable. In this case, in particular, leakage of the electrolytic solution is prevented, as described above. Accordingly, it is possible to achieve higher effects.

Applications (application examples) of the secondary battery will be described according to an embodiment.

The applications of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one secondary battery, or may each use multiple secondary batteries.

The battery packs may each include a single battery, or may each include an assembled battery. The electric vehicle is a vehicle that operates (travels) using the secondary battery as a driving power source, and may be a hybrid automobile that is additionally provided with a driving source other than the secondary battery. In an electric power storage system for home use, electric power accumulated in the secondary battery which is an electric power storage source may be utilized for using, for example, home appliances.

An example of the application of the secondary battery will now be described in detail. The configuration described below is merely an example, and is appropriately modifiable.

FIG. 3 illustrates a block configuration of a battery pack. The battery pack described here is a battery pack (a so-called soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a thermosensitive resistive device (a so-called PTC device) 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.2 V±0.05 V. The overdischarge detection voltage is not particularly limited, and is specifically 2.4 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). The charging and discharging currents are detected based on an ON-resistance of the switch 57.

The temperature detector 59 includes a temperature detection device such as a thermistor. The temperature detector 59 measures a temperature of the electric power source 51 using the temperature detection terminal 55, and outputs a result of the temperature measurement to the controller 56. The result of the temperature measurement to be obtained by the temperature detector 59 is used, for example, in a case where the controller 56 performs charge/discharge control upon abnormal heat generation or in a case where the controller 56 performs a correction process upon calculating a remaining capacity.

### EXAMPLES

A description is provided of Examples of the present technology according to an embodiment.

### Examples 1 to 37 and Comparative Examples 1 to 6

Secondary batteries were fabricated, following which the secondary batteries were each evaluated for a battery characteristic as described below.

### [Fabrication of Secondary Battery]

The secondary batteries (the lithium-ion secondary batteries of the laminated-film type) illustrated in FIGS. 1 and 2 were fabricated in accordance with the following procedure.

### (Fabrication of Positive Electrode)

First, 91 parts by mass of the positive electrode active material (lithium cobalt oxide (LiCoO₂)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone which was the organic solvent), following which the organic solvent was stirred to thereby prepare a positive electrode mixture slurry in a paste form. Thereafter, the positive electrode mixture slurry was applied on the two opposed surfaces of the positive electrode current collector 21A (a band-shaped aluminum foil having a thickness of 12 μm) by means of a coating apparatus, following which the applied positive electrode mixture slurry was dried to thereby form the positive electrode active material layers 21B. Lastly, the positive electrode active material layers 21B were compression-molded by means of a roll pressing machine. In this manner, the positive electrode 21 was fabricated.

### (Fabrication of Negative Electrode)

First, 93 parts by mass of the negative electrode active material (artificial graphite which was the carbon material) and 7 parts by mass of the negative electrode binder (polyvinylidene difluoride) were mixed with each other to thereby obtain a negative electrode mixture. Thereafter, the negative electrode mixture was put into a solvent (N-methyl-2-pyrrolidone which was the organic solvent), following which the organic solvent was stirred to thereby prepare a negative electrode mixture slurry in a paste form. Thereafter, the negative electrode mixture slurry was applied on the two opposed surfaces of the negative electrode current collector 22A (a band-shaped copper foil having a thickness of 15 μm) by means of a coating apparatus, following which the applied negative electrode mixture slurry was dried to thereby form the negative electrode active material layers 22B. Lastly, the negative electrode active material layers 22B were compression-molded by means of a roll pressing machine. In this manner, the negative electrode 22 was fabricated.

### (Preparation of Electrolytic Solution)

First, the solvent was prepared. Used as the solvent were ethylene carbonate which was the carbonic-acid-ester-based compound (the cyclic carbonic acid ester), propyl propionate which was the carboxylic-acid-ester-based compound (the chain carboxylic acid ester), and ethyl propionate which was the carboxylic-acid-ester-based compound (the chain carboxylic acid ester). A mixture ratio (a weight ratio) of the solvent between ethylene carbonate, propyl propionate, and ethyl propionate was set to 30:40:30.

Thereafter, the electrolyte salt (lithium hexafluorophosphate (LiPF₆)) was added to the solvent, following which the solvent was stirred. A content of the electrolyte salt was set to 1 mol/kg with respect to the solvent.

Thereafter, the additives (vinylene carbonate which was the unsaturated cyclic carbonic acid ester, and monofluoroethylene carbonate which was the halogenated carbonic acid ester) were added to the solvent, following which the solvent was stirred.

Lastly, the diester compound and the sulfur-containing compound were added to the solvent, following which the solvent was stirred. Respective kinds of the diester compounds (the first diester compound, the second diester compound, and the third diester compound) and the sulfur-containing compound were as listed in Tables 1 to 3.

Used as the sulfur-containing compound were propane sultone (PS), 1,4-butane sultone (BS1), 2,4-butane sultone (BS2), propene sultone (PRS), glycol sulfate (GS), propylene glycol sulfate (PGS), dimethyl sulfate (DMS), diethyl sulfate (DES), ethyl methyl sulfate (EMS), and sulfolane (SF).

The electrolyte salt, the additive, the diester compound, and the sulfur-containing compound were each thus dispersed or dissolved in the solvent. As a result, the electrolytic solution was prepared.

For comparison, the electrolytic solution was prepared by a similar procedure except that neither the diester compound nor the sulfur-containing compound was used.

Further, for comparison, the electrolytic solution was prepared by a similar procedure except that only one of the first diester compound, the second diester compound, or the third diester compound was used as the diester compound.

### (Assembly of Secondary Battery)

First, the positive electrode lead 31 (aluminum) was welded to the positive electrode current collector 21A of the positive electrode 21, and the negative electrode lead 32 (copper) was welded to the negative electrode current collector 22A of the negative electrode 22.

Thereafter, the positive electrode 21 and the negative electrode 22 were stacked on each other with the separator 23 (a fine porous polyethylene film having a thickness of 15 μm) interposed therebetween, following which the stack of the positive electrode 21, the negative electrode 22, and the separator 23 was wound to thereby fabricate a wound body. Thereafter, the wound body was pressed by means of a pressing machine, and was thereby shaped into an elongated shape.

Thereafter, the outer package film 10 (the fusion-bonding layer/the metal layer/the surface protective layer) was folded in such a manner as to sandwich the wound body contained inside the depression part 10U. Thereafter, the outer edge parts of two sides of the outer package film 10 (the fusion-bonding layer) were thermal-fusion-bonded to each other to thereby allow the wound body to be contained inside the outer package film 10 having the pouch shape. As the outer package film 10, an aluminum laminated film was used in which the fusion-bonding layer (a polypropylene film having a thickness of 30 μm), the metal layer (an aluminum foil having a thickness of 40 μm), and the surface protective layer (a nylon film having a thickness of 25 μm) were stacked in this order from an inner side.

Lastly, the electrolytic solution was injected into the outer package film 10 having the pouch shape and thereafter, the outer edge parts of the remaining one side of the outer package film 10 (the fusion-bonding layer) were thermal-fusion-bonded to each other in a reduced-pressure environment. In this case, the sealing film 41 (a polypropylene film having a thickness of 5 μm) was interposed between the outer package film 10 and the positive electrode lead 31, and the sealing film 42 (a polypropylene film having a thickness of 5 μm) was interposed between the outer package film 10 and the negative electrode lead 32.

In this manner, the wound body was impregnated with the electrolytic solution. As a result, the battery device 20 was fabricated. Accordingly, the battery device 20 was sealed in the outer package film 10. As a result, the secondary battery was assembled.

### (Stabilization of Secondary Battery)

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of 4.2 V until a current reached 0.05 C. Upon discharging, the secondary battery was discharged with a constant current of 0.1 C until the voltage reached 3.0 V. Note that 0.1 C was a value of a current that caused a battery capacity (a theoretical capacity) to be completely discharged in 10 hours, and 0.05 C was a value of a current that caused the battery capacity to be completely discharged in 20 hours.

A film was thus formed on the surface of each of the positive electrode 21 and the negative electrode 22, and the state of the secondary battery was therefore electrochemically stabilized. As a result, the secondary battery was completed.

After the completion of the secondary battery, the electrolytic solution was analyzed by inductively coupled plasma (ICP) optical emission spectroscopy. As a result, a content of the unsaturated cyclic carbonic acid ester in the electrolytic solution was 1 wt %, and a content of the halogenated carbonic acid ester in the electrolytic solution was 1 wt %. Respective contents (wt %) of the diester compound (the first diester compound, the second diester compound, and the third diester compound) and the sulfur-containing compound in the electrolytic solution were as listed in Tables 1 to 3.

Tables 1 to 3 each present respective contents of the first diester compound, the second diester compound, and the third diester compound, and also present the content of the diester compound (the sum total of the respective contents of the first diester compound, the second diester compound, and the third diester compound).

### [Evaluation of Battery Characteristic]

Evaluation of the secondary batteries for their battery characteristics (their high-temperature storage characteristics) revealed the results presented in Tables 1 to 3.

In a case of examining the high-temperature storage characteristic, first, the secondary battery was charged and discharged for one cycle in an ambient temperature environment (at a temperature of 25° C.) to thereby measure a first-cycle discharge capacity (a pre-storage discharge capacity). Charging and discharging conditions were similar to the charging and discharging conditions for the stabilization of the secondary battery described above.

Thereafter, the charged secondary battery was stored (for a storage period of four weeks) in a high-temperature environment (at a temperature of 60° C.).

Thereafter, the secondary battery after the storage was charged and discharged for three cycles in the ambient-temperature environment to thereby measure a fourth-cycle discharge capacity (a post-storage discharge capacity). Charging and discharging conditions were similar to the charging and discharging conditions for the stabilization of the secondary battery described above, except that the current at the time of charging and the current at the time of discharging were each changed to ⅓ C. Note that ⅓ C was a value of a current that caused the battery capacity to be completely discharged in three hours.

Lastly, a capacity retention rate which was an index for evaluating the high-temperature storage characteristic was calculated based on the following calculation expression: capacity retention rate (%)=(post-storage discharge capacity/pre-storage discharge capacity)×100.

TABLE 1

| | Diester compound | | | | | | | | | |
|---|---|---|---|---|---|---|---|---|---|---|
| | First diester | | Second diester | | Third diester | | | Sulfur-containing | | Capacity |
| | compound | | compound | | compound | | | compound | | retention |
| | | Content | | Content | | Content | Content | | Content | rate |
| | Kind | (wt %) | Kind | (wt %) | Kind | (wt %) | (wt %) | Kind | (wt %) | (%) |
| Example 1 | Formula | 0.001 | Formula | 0.001 | — | — | 0.002 | PS | 1 | 80 |
| | (1-4) | | (2-5) | | | | | | | |
| Example 2 | Formula | 0.002 | Formula | 0.003 | — | — | 0.005 | PS | 1 | 84 |
| | (1-4) | | (2-5) | | | | | | | |
| Example 3 | Formula | 0.05 | Formula | 0.05 | — | — | 0.1 | PS | 1 | 85 |
| | (1-4) | | (2-5) | | | | | | | |
| Example 4 | Formula | 0.5 | Formula | 0.5 | — | — | 1 | PS | 1 | 87 |
| | (1-4) | | (2-5) | | | | | | | |
| Example 5 | Formula | 1 | Formula | 1 | — | — | 2 | PS | 1 | 83 |
| | (1-4) | | (2-5) | | | | | | | |
| Example 6 | — | — | Formula | 0.001 | Formula | 0.001 | 0.002 | PS | 1 | 00 |
| | | | (2-5) | | (3-4) | | | | | |
| Example 7 | — | — | Formula | 0.002 | Formula | 0.003 | 0.005 | PS | 1 | 84 |
| | | | (2-5) | | (3-4) | | | | | |
| Example 8 | — | — | Formula | 0.05 | Formula | 0.05 | 0.1 | PS | 1 | 85 |
| | | | (2-5) | | (3-4) | | | | | |
| Example 9 | — | — | Formula | 0.5 | Formula | 0.5 | 1 | PS | 1 | 86 |
| | | | (2-5) | | (3-4) | | | | | |
| Example 10 | — | — | Formula | 1 | Formula | 1 | 2 | PS | 1 | 83 |
| | | | (2-5) | | (3-4) | | | | | |
| Example 11 | Formula | 0.001 | — | — | Formula | 0.001 | 0.002 | PS | 1 | 80 |
| | (1-4) | | | | (3-4) | | | | | |
| Example 12 | Formula | 0.003 | — | — | Formula | 0.002 | 0.005 | PS | 1 | 84 |
| | (1-4) | | | | (3-4) | | | | | |
| Example 13 | Formula | 0.05 | — | — | Formula | 0.05 | 0.1 | PS | 1 | 85 |
| | (1-4) | | | | (3-4) | | | | | |
| Example 14 | Formula | 0.5 | — | — | Formula | 0.5 | 1 | PS | 1 | 86 |
| | (1-4) | | | | (3-4) | | | | | |
| Example 15 | Formula | 1 | — | — | Formula | 1 | 2 | PS | 1 | 82 |
| | (1-4) | | | | (3-4) | | | | | |

TABLE 2

| | Diester compound | | | | | | | | | |
|---|---|---|---|---|---|---|---|---|---|---|
| | First diester | | Second diester | | Third diester | | | Sulfur-containing | | Capacity |
| | compound | | compound | | compound | | | compound | | retention |
| | | Content | | Content | | Content | Content | | Content | rate |
| | Kind | (wt %) | Kind | (wt %) | Kind | (wt %) | (wt %) | Kind | (wt %) | (%) |
| Example 16 | Formula | 0.05 | Formula | 0.05 | — | — | 0.1 | PS | 1 | 86 |
| | (1-4) | | (2-12) | | | | | | | |
| Example 17 | Formula | 0.05 | Formula | 0.05 | — | — | 0.1 | PS | 1 | 86 |
| | (1-4) | | (2-20) | | | | | | | |
| Example 18 | Formula | 0.05 | Formula | 0.05 | — | — | 0.1 | PS | 1 | 85 |
| | (1-4) | | (2-21) | | | | | | | |
| Example 19 | — | — | Formula | 0.05 | Formula | 0.05 | 0.1 | PS | 1 | 85 |
| | | | (2-5) | | (3-5) | | | | | |
| Example 20 | — | — | Formula | 0.05 | Formula | 0.05 | 0.1 | PS | 1 | 86 |
| | | | (2-5) | | (3-8) | | | | | |
| Example 21 | — | — | Formula | 0.05 | Formula | 0.05 | 0.1 | PS | 1 | 85 |
| | | | (2-5) | | (3-12) | | | | | |
| Example 22 | Formula | 0.05 | — | — | Formula | 0.05 | 0.1 | PS | 1 | 86 |
| | (1-1) | | | | (3-4) | | | | | |
| Example 23 | Formula | 0.05 | — | — | Formula | 0.05 | 0.1 | PS | 1 | 8 |
| | (1-7) | | | | (3-4) | | | | | |
| Example 24 | Formula | 0.05 | — | — | Formula | 0.05 | 0.1 | PS | 1 | 85 |
| | (1-11) | | | | (3-4) | | | | | |
| Example 25 | Formula | 0.05 | Formula | 0.05 | — | — | 0.1 | PS | 0.05 | 83 |
| | (1-4) | | (2-5) | | | | | | | |
| Example 26 | Formula | 0.05 | Formula | 0.05 | — | — | 0.1 | PS | 0.1 | 85 |
| | (1-4) | | (2-5) | | | | | | | |
| Example 27 | Formula | 0.05 | Formula | 0.05 | — | — | 0.1 | PS | 3 | 86 |
| | (1-4) | | (2-5) | | | | | | | |
| Example 28 | Formula | 0.05 | Formula | 0.05 | — | — | 0.1 | PS | 5 | 83 |
| | (1-4) | | (2-5) | | | | | | | |

TABLE 3

| | Diester compound | | | | | | | | | |
|---|---|---|---|---|---|---|---|---|---|---|
| | First diester | | Second diester | | Third diester | | | Sulfur-containing | | Capacity |
| | compound | | compound | | compound | | | compound | | retention |
| | | Content | | Content | | Content | Content | | Content | rate |
| | Kind | (wt %) | Kind | (wt %) | Kind | (wt %) | (wt %) | Kind | (wt %) | (%) |
| Example 29 | Formula | 0.05 | Formula | 0.05 | — | — | 0.1 | BS1 | 1 | 86 |
| | (1-4) | | (2-5) | | | | | | | |
| Example 30 | Formula | 0.05 | Formula | 0.05 | — | — | 0.1 | BS2 | 1 | 86 |
| | (1-4) | | (2-5) | | | | | | | |
| Example 31 | Formula | 0.05 | Formula | 0.05 | — | — | 0.1 | PRS | 1 | 85 |
| | (1-4) | | (2-5) | | | | | | | |
| Example 32 | Formula | 0.05 | Formula | 0.05 | — | — | 0.1 | GS | 1 | 84 |
| | (1-4) | | (2-5) | | | | | | | |
| Example 33 | Formula | 0.05 | Formula | 0.05 | — | — | 0.1 | PGS | 1 | 83 |
| | (1-4) | | (2-5) | | | | | | | |
| Example 34 | Formula | 0.05 | Formula | 0.05 | — | — | 0.1 | DMS | 1 | 82 |
| | (1-4) | | (2-5) | | | | | | | |
| Example 35 | Formula | 0.05 | Formula | 0.05 | — | — | 0.1 | DES | 1 | 85 |
| | (1-4) | | (2-5) | | | | | | | |
| Example 36 | Formula | 0.05 | Formula | 0.05 | — | — | 0.1 | EMS | 1 | 83 |
| | (1-4) | | (2-5) | | | | | | | |
| Example 37 | Formula | 0.05 | Formula | 0.05 | — | — | 0.1 | SF | 1 | 85 |
| | (1-4) | | (2-5) | | | | | | | |
| Comparative | — | — | — | — | — | — | 0.1 | — | — | 70 |
| example 1 | | | | | | | | | | |
| Comparative | Formula | 0.1 | — | — | — | — | 0.1 | PS | 1 | 71 |
| example 2 | (1-4) | | | | | | | | | |
| Comparative | — | — | Formula | 0.1 | — | — | 0.1 | PS | 1 | 71 |
| example 3 | | | (2-5) | | | | | | | |
| Comparative | — | — | — | — | Formula | 0.1 | 0.1 | PS | 1 | 70 |
| example 4 | | | | | (3-4) | | | | | |
| Comparative | Formula | 0.1 | — | — | — | — | 0.1 | GS | 1 | 71 |
| example 5 | (1-4) | | | | | | | | | |
| Comparative | — | — | — | — | Formula | 0.1 | 0.1 | PGS | 1 | 71 |
| example 6 | | | | | (3-4) | | | | | |

As indicated in Tables 1 to 3, the capacity retention rate varied greatly depending on the configuration of the electrolytic solution. In the following, the capacity retention rate in a case where the electrolytic solution included neither the diester compound nor the sulfur-containing compound (Comparative example 1) is set as a comparison reference.

In a case where the electrolytic solution included both the diester compound and the sulfur-containing compound, but where the diester compound included only one of the first diester compound, the second diester compound, or the third diester compound (Comparative examples 2 to 6), the capacity retention rate hardly increased.

In contrast, the capacity retention rate greatly increased in a case where the electrolytic solution included both the diester compound and the sulfur-containing compound, and where the diester compound included two or more of the first diester compound, the second diester compound, or the third diester compound (Examples 1 to 37).

In this case, if the diester compound included the combination of the first diester compound and the second diester compound, in particular, the capacity retention rate further increased. If the content of the diester compound in the electrolytic solution was within the range from 0.005 wt % to 1 wt % both inclusive, and if the content of the sulfur-containing compound in the electrolytic solution was within the range from 0.1 wt % to 3 wt % both inclusive, the capacity retention rate further increased.

Here, a specific examination was not conducted on a case where the diester compound included all of the first diester compound, the second diester compound, and the third diester compound. However, based on that a high capacity retention rate was achieved in the case where the diester compound included two of the first diester compound, the second diester compound, or the third diester compound, it was obvious that a high capacity retention rate would be achieved in a similar manner also in the case where the diester compound included all of the first diester compound, the second diester compound, and the third diester compound.

Based upon the results presented in Tables 1 to 3, in a case where: the electrolytic solution included the diester compound and the sulfur-containing compound; the diester compound included two or more of the first diester compound, the second diester compound, or the third diester compound; and the sulfur-containing compound included, without limitation, propane sultone, a high capacity retention rate was obtained. The secondary battery therefore achieved a superior high-temperature storage characteristic.

Although the present technology has been described herein with reference to one or more embodiments including Examples, the configuration of the present technology is not limited thereto, and is therefore modifiable in a variety of suitable ways.

For example, the description has been given of the case where the secondary battery has a battery structure of the laminated-film type. However, the battery structure of the secondary battery is not particularly limited, and may therefore be, for example, a cylindrical type, a prismatic type, a coin type, or a button type.

Further, the description has been given of the case where the battery device has a device structure of a wound type. However, the device structure of the battery device is not particularly limited, and may therefore be a stacked type in which the positive electrode and the negative electrode are stacked on each other, a zigzag folded type in which the positive electrode and the negative electrode are folded in a zigzag manner, or any other type.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

Note that the application of the electrolytic solution described above is not limited to the secondary battery. The electrolytic solution may therefore be applied to another electrochemical unit such as a capacitor.

The effects described herein are mere examples, and effects of the present technology are therefore not limited to those described herein. Accordingly, the present technology may achieve any other suitable effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution including a diester compound and a sulfur-containing compound, wherein
the diester compound includes two or more of a compound represented by Formula (1), a compound represented by Formula (2), or a compound represented by Formula (3), and
the sulfur-containing compound includes at least one of propane sultone, 1,4-butane sultone, 2,4-butane sultone, propene sultone, glycol sulfate, propylene glycol sulfate, dimethyl sulfate, diethyl sulfate, ethyl methyl sulfate, or sulfolane, 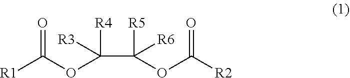
where
each of R1 and R2 is one of a methyl group, an ethyl group, a propyl group, or a fluorine group, and
each of R3 to R6 is one of a hydrogen group, a methyl group, or a fluorine group, 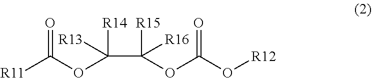
where
R11 is one of a methyl group, an ethyl group, a propyl group, or a fluorine group,
R12 is one of a methyl group, an ethyl group, or a propyl group, and
each of R13 to R16 is one of a hydrogen group, a methyl group, or a fluorine group, 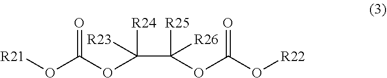
where
each of R21 and R22 is one of a methyl group, an ethyl group, or a propyl group, and
each of R23 to R26 is one of a hydrogen group, a methyl group, or a fluorine group.

2. The secondary battery according to claim 1, wherein the diester compound includes the compound represented by Formula (1) and the compound represented by Formula (2).

3. The secondary battery according to claim 1, wherein a content of the diester compound in the electrolytic solution is greater than or equal to 0.005 weight percent and less than or equal to 1 weight percent.

4. The secondary battery according to claim 1, wherein a content of the sulfur-containing compound in the electrolytic solution is greater than or equal to 0.1 weight percent and less than or equal to 3 weight percent.

5. The secondary battery according to claim 1, wherein the secondary battery comprises a lithium-ion secondary battery.

6. An electrolytic solution for a secondary battery, the electrolytic solution comprising:
a diester compound; and
a sulfur-containing compound, wherein
the diester compound includes two or more of a compound represented by Formula (1), a compound represented by Formula (2), or a compound represented by Formula (3), and
the sulfur-containing compound includes at least one of propane sultone, 1,4-butane sultone, 2,4-butane sultone, propene sultone, glycol sulfate, propylene glycol sulfate, dimethyl sulfate, diethyl sulfate, ethyl methyl sulfate, or sulfolane, 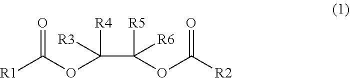
where
each of R1 and R2 is one of a methyl group, an ethyl group, a propyl group, or a fluorine group, and
each of R3 to R6 is one of a hydrogen group, a methyl group, or a fluorine group, 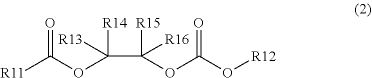
where
R11 is one of a methyl group, an ethyl group, a propyl group, or a fluorine group,
R12 is one of a methyl group, an ethyl group, or a propyl group, and
each of R13 to R16 is one of a hydrogen group, a methyl group, or a fluorine group, 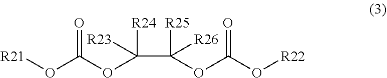
where
each of R21 and R22 is one of a methyl group, an ethyl group, or a propyl group, and
each of R23 to R26 is one of a hydrogen group, a methyl group, or a fluorine group.
